(19) United States
(12) Patent Application Publication
(10) Pub. No.: US 2009/0153651 A1
(43) Pub. Date: Jun. 18, 2009

(54) SUSPENDED PARTICLE DEVICE

(75) Inventors: Nynke A.M. Verhaegh, Eindhoven (NL); Dirk K.G. De Boer, Den Bosch (NL); Mark T. Johnson, Veldhoven (NL); Bas Van Der Heijden, Hoogeloon (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,872

(22) PCT Filed: Jan. 5, 2005
(86) PCT No.: PCT/IB05/50044

§ 371 Date: Jun. 28, 2006

(30) Foreign Application Priority Data
Jan. 8, 2004 (GB) 0400288.7

(51) Int. Cl. H04N 13/00; G02F 1/167

(52) U.S. Cl. 348/54; 359/296; 348/E13.031

(57) ABSTRACT

The invention relates to a 3 D display. The 3 D display comprises suspended particle devices with a suspension of elongated particles that align at a predetermined angle with incoming light beam. The display will allow information to be separated relevant to the left and right eye. An electronically controllable set of suspended particle devices adjusts the deflection angle of the outcoming light beam.

The invention relates to a 3 D display and more specifically it relates to the use of electro-optical cells comprising a particle suspension in order to control the direction of the optical radiation transmitted or reflected by the display.

Suspended particle devices (SPDs) are used as light shutters and light valves in applications requiring control of light and are switchable between a transmissive and a non-transmissive state. They can for example be used in screens for personal computers and mobile telecommunication devices in combination with LCD screens. The SPD can transmit light from a backlight to the LCD screen when the environment of the screen is dark, or, when there is bright light in front of the screen, the SPD can reflect light from the surroundings instead of using the backlight.

Conventional SPDs comprise first and second generally parallel, spaced apart support members, such as glass plates, with a suspended particle medium between them. The suspended particle medium may comprise elongated reflecting particles in a supporting liquid. Electrodes are provided on the support members for applying an electric field to the suspended particles in one or more individual cells. The particles adopt a random orientation in the absence of an applied field. Early SPDs use the random orientation of the suspended particles to provide the non-transmissive state. Incident light is obstructed by the randomly oriented particles and is scattered. Improved SPDs use an electric field perpendicular to the direction of the light to provide the non-transmissive state. The particles align with the applied field with their large area perpendicular to the direction of the light resulting in a highly reflective state. The advantage of this state is the increased reflectivity and the fast switching times. The transmissive state is formed by applying an electric field in the direction of the light, making the particles align with their long axis parallel to the direction of the incident light, reducing the scattering considerably.

Research about 3 D displays is becoming more popular and widespread. A variety of autostereoscopic screens already exist that allows the viewer to see a 3 D image without using filters and special glasses. An example of such a screen can be found in “Multiview 3 D-LCD” by C. van Berkel et al in SPIE Proceedings, Vol. 2653, 1996, pages 32-39.

A 3 D image appears when the display shows two images, one for the left eye and one for the right eye where the two images are slightly shifted to account for parallax between the two eyes. Pixels containing information for each image are interspersed in recurring patterns on the screen. The light emitted from the screen is controlled so that the light passing through the pixels containing information for the left eye is subsequently directed towards the left eye and light passing through the pixel containing information for the right eye is subsequently directed towards the right eye. The light beams associated with each pair of pixels need to enter the pixels at the correct angle. The directions of the beams are usually controlled by having a backlight emitting light in thin parallel slits at the appropriate intervals, as in U.S. Pat. No. 4,717,949, or by having a filter with slits between the light and the pixels or using lenticular lenses to spread the light at the appropriate angle, as disclosed in GB-A-2196166. However, none of these methods provide a screen where the direction of the light can be changed during operation. Consequently, it is not possible to switch the screen into a 2 D display mode. It is further not possible to change the direction of the light as a function of the position of the viewer. Research has been reported about displays that contain a switchable diffusive filter to scatter the directional light before the light is emitted and thus being able to change the display mode from 2 D to 3 D. Example of such research can be found in “A lightweight, compact 2 D/3 D autostereoscopic lcd backlight” by J. Eichenlaub et al in SPIE Proceedings, Vol. 3295, 1998, pages 180-185. However, a diffusive filter often reduces the efficiency of the screen. Furthermore, only images containing a specific number of views can be displayed on any particular screen since the direction of the light from each view is fixed at the point of manufacture and cannot be changed afterwards.

According to the invention there is provided an electro-optical cell comprising first and second support members at least one of which is transparent to optical radiation, a suspension of particles between the support members, and an electrode arrangement on at least the first support member to apply an electric field to the particle suspension in such a manner that at least a major proportion of the particles are aligned in an oblique configuration relative to the support members in a predetermined region thereof so as to guide obliquely the optical radiation passing between the support members.

There is further provided a display comprising a light source, a display device comprising an array of pixels, and a plurality of the electro-optical cells described above.

An advantage of the invention is that the direction of the light is controlled by electrical forces and can be altered during operation. The light emitted by a backlight can be directed by the electro-optical cells to the appropriate pixel and subsequently directed to the appropriate eye to form an adjustable 3 D image. If the viewer changes positions or the number of views of the 3 D image is increased or decreased the direction of the light beams can be changed accordingly.

The invention further provides a display that is operable to provide a first display window which is switchable to transmissive mode, wherein the size of the window corresponds to the size of a group of electro-optical cells, said group comprises at least one electro-optical cell, and the electro-optical cells of the group are operable to apply an electric field, perpendicular to the support members, to the particle suspensions of said group in such a manner that at least a major proportion of the particles in said group are aligned in a configuration perpendicular to the support members in a predetermined region thereof so as to cause negligible obstruction to the optical radiation passing between the support members.

If the pixels corresponding to said first window further contain information for a 2 D image the window can be switched between a 2 D and 3 D display mode.

Yet further the invention provides a display that is operable to provide a second window which is switchable to reflective mode, wherein the size of the window corresponds to the size of a group of electro-optical cells, said group comprises at least one electro-optical cell, and the electro-optical cells of the group are operable to apply an electric field, aligned with the support members, to the particle suspensions of said group in such a manner that at least a major proportion of the particles in said group are aligned with the support members in a predetermined region thereof so as to reflect the optical radiation passing between them.

If the pixels are situated behind the reflective electro-optical cells said second window will appear as a mirror in the reflective mode and if the pixels are situated in front of the reflective electro-optical cell and the pixels contain information for a 2 D image the environmental light can be used to illuminate a 2 D image in the window.

A further advantage of the invention is that since the electro-optical cell can transmit, reflect and deflect light at. a number of oblique angles the direction of the light can be adjusted to accommodate different users or operation at different distances.

Embodiments of the invention will now be described by way of example with reference to the accompanying drawings, in which:

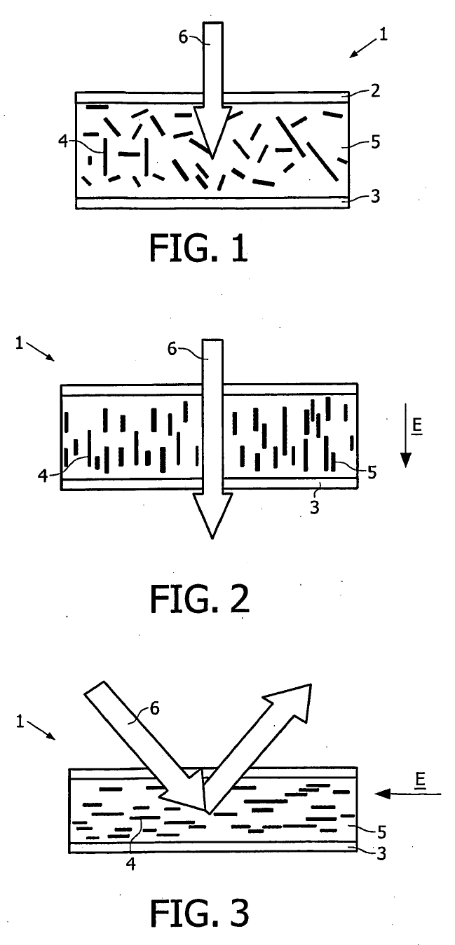

FIG. 1 is a schematic sectional view of an electro-optical cell in the 3 D display where the suspended particles are in a random state;

FIG. 2 is a schematic sectional view of an electro-optical cell of the 3 D display where the suspended particles are in a transmissive state;

FIG. 3 is a schematic sectional view of an electro-optical cell of the display where the suspended particles are in a reflective state;

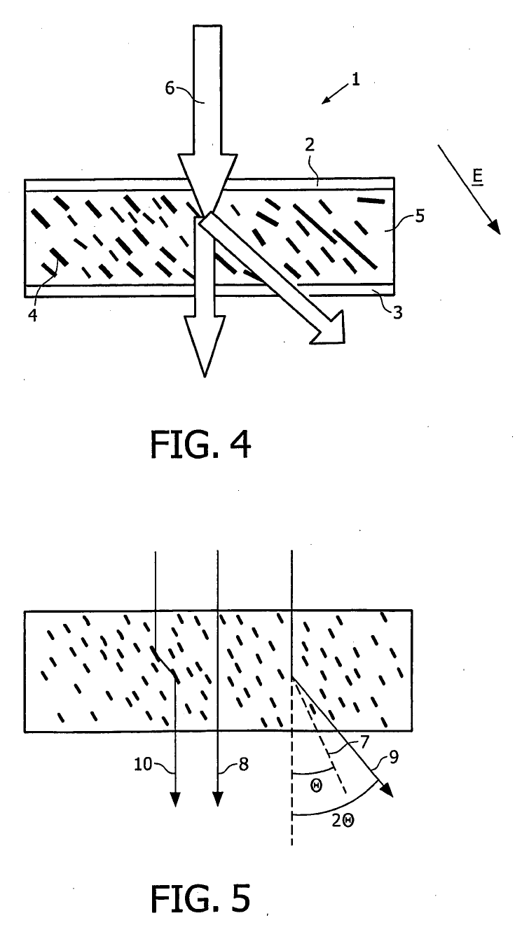

FIG. 4 is a schematic sectional view of an electro-optical cell of the display where the suspended particles are in a partly deflective state;

FIG. 5 is a schematic diagram showing the path of the light in the electro-optical cell of FIG. 4;

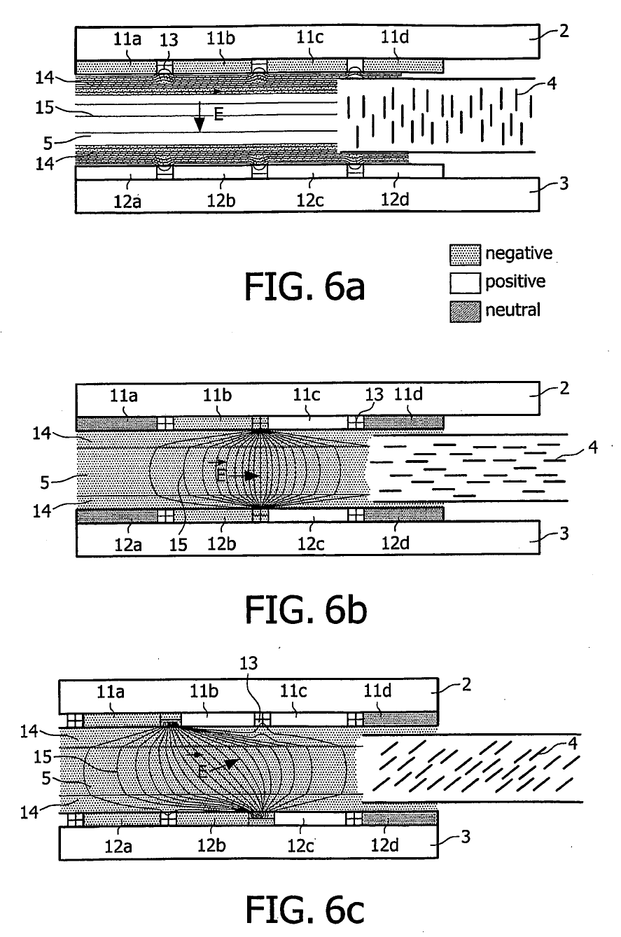

FIGS. 6(a)-(c) are sectional views of an electro-optical cell of the display subject to electrical fields perpendicular, parallel and at an oblique angle to the plane of the display respectively, with an enlarged illustration of the alignment of the suspended particles on the right hand side;

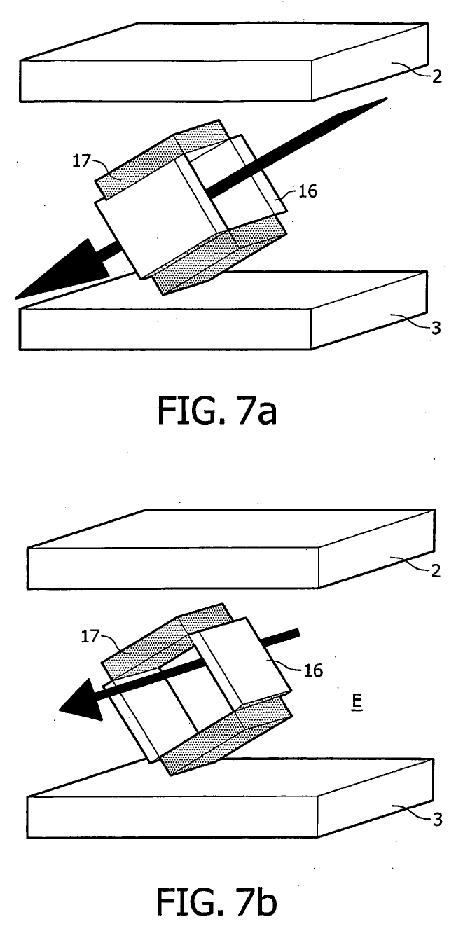

FIGS. 7(a)-(b) illustrate the degrees of freedom of a suspended particle in an electro-optical cell of the display;

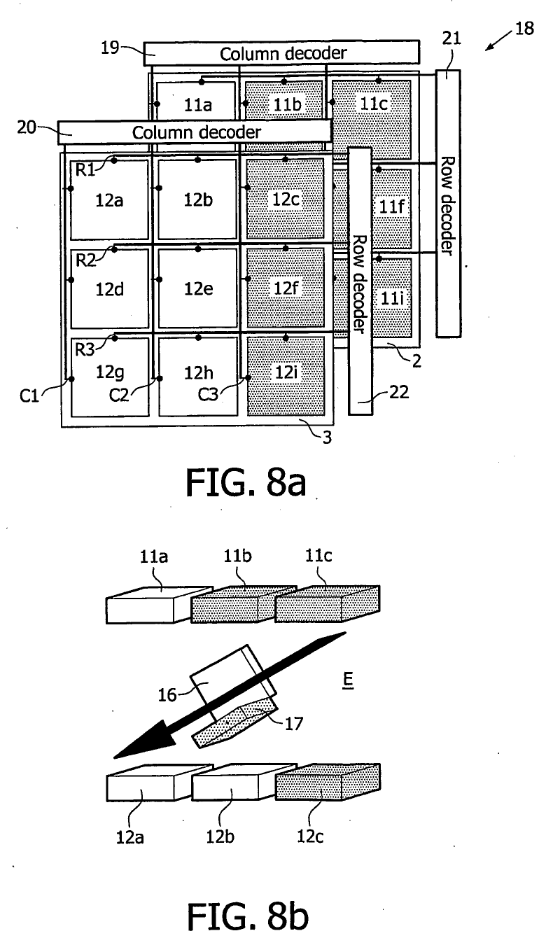

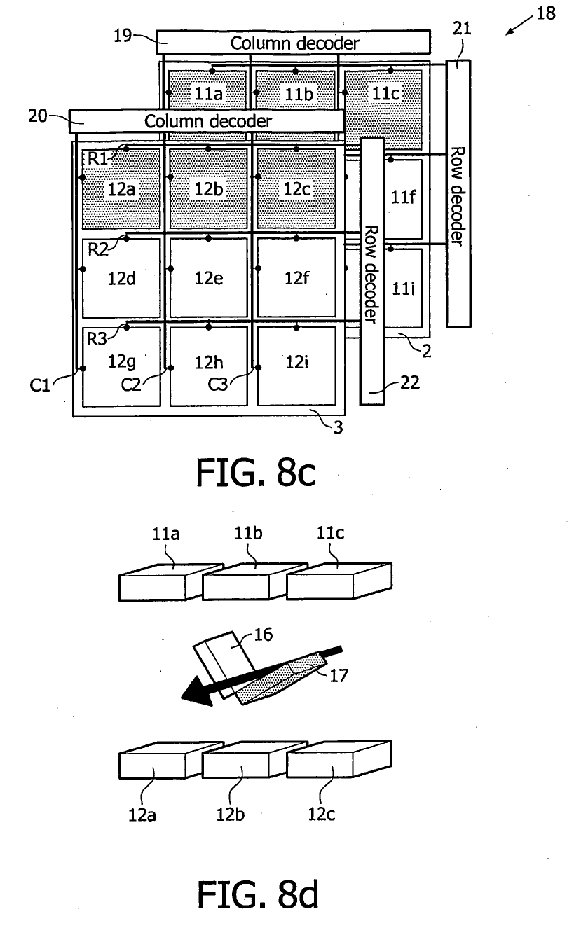

FIGS. 8(a)-(d) show a detailed embodiment of the electro-optical cell of the display in a deflective state;

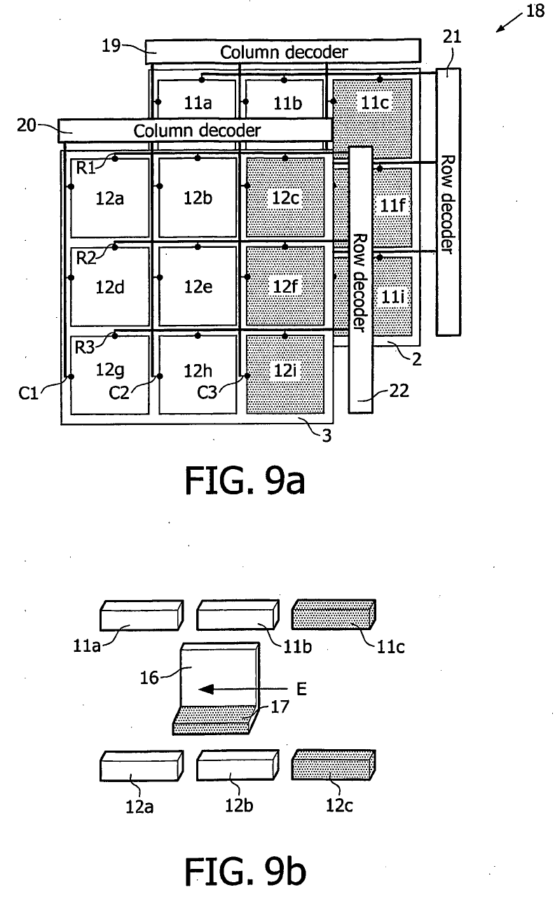

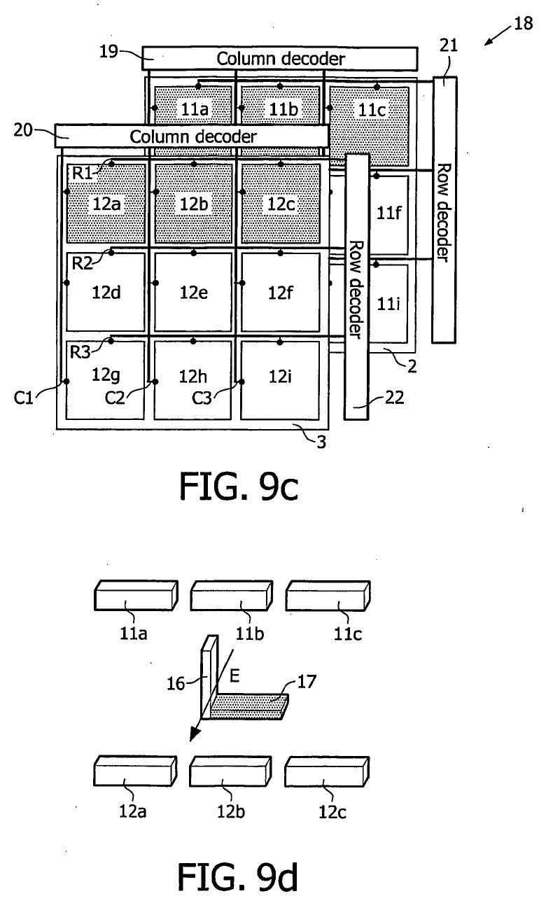

FIGS. 9(a)-(d) show the electro-optical cell of FIG. 8 in a reflective state;

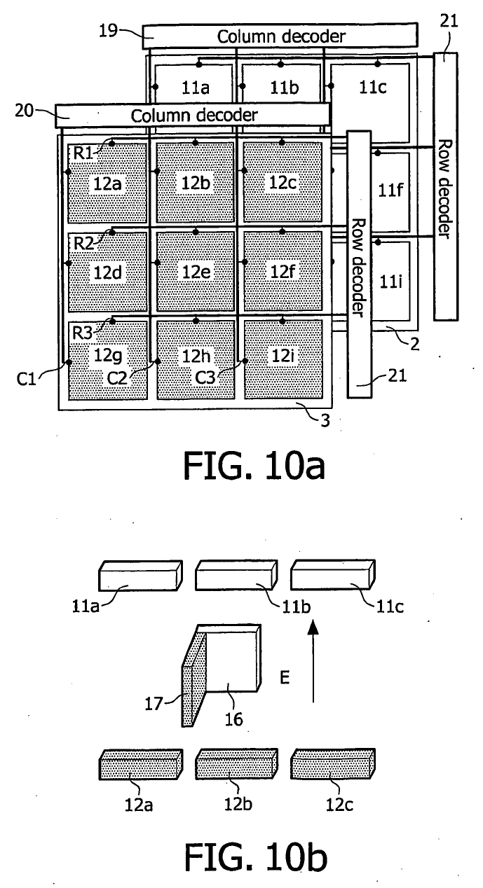

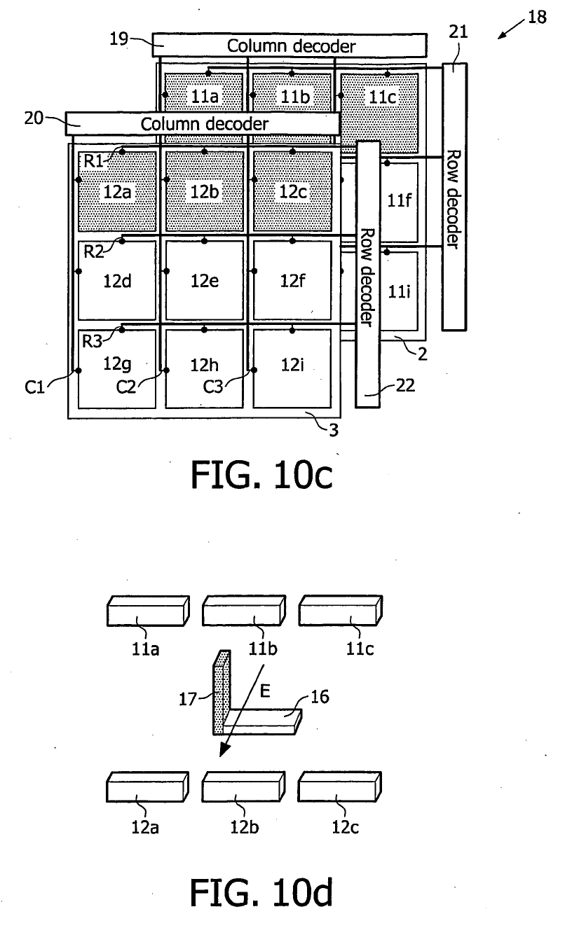

FIGS. 10(a)-(d) show the electro-optical cell of FIGS. 8 and 9 in a transmissive state;

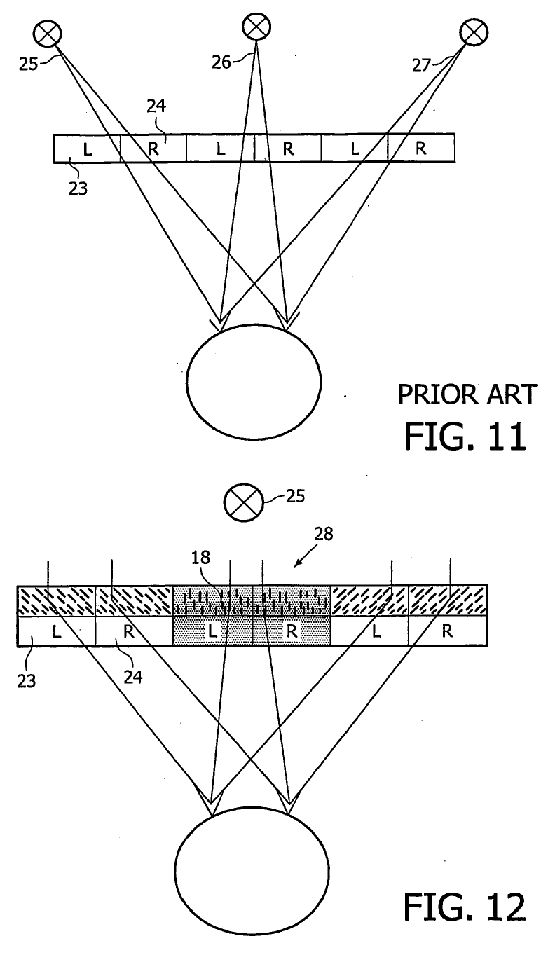

FIG. 11 illustrates how a 3 D image is formed;

FIG. 12 illustrates how a 3 D image is formed utilising suspended particle devices for deflecting the light;

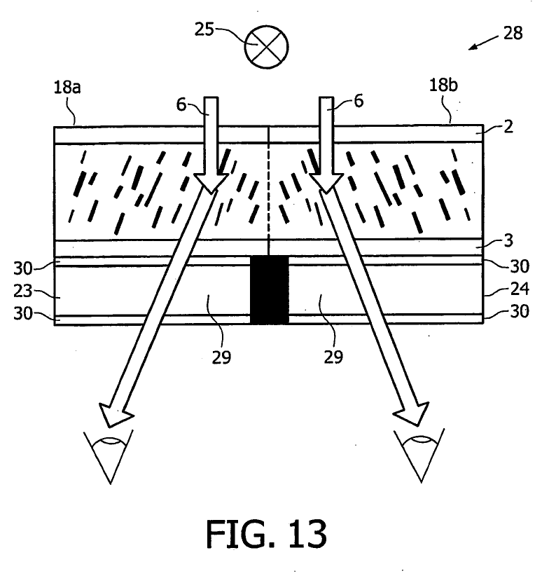

FIG. 13 shows part of a display containing two electro-optical cells directing each of the two light beams into the appropriate eyes through separate liquid crystal (LC) pixels;

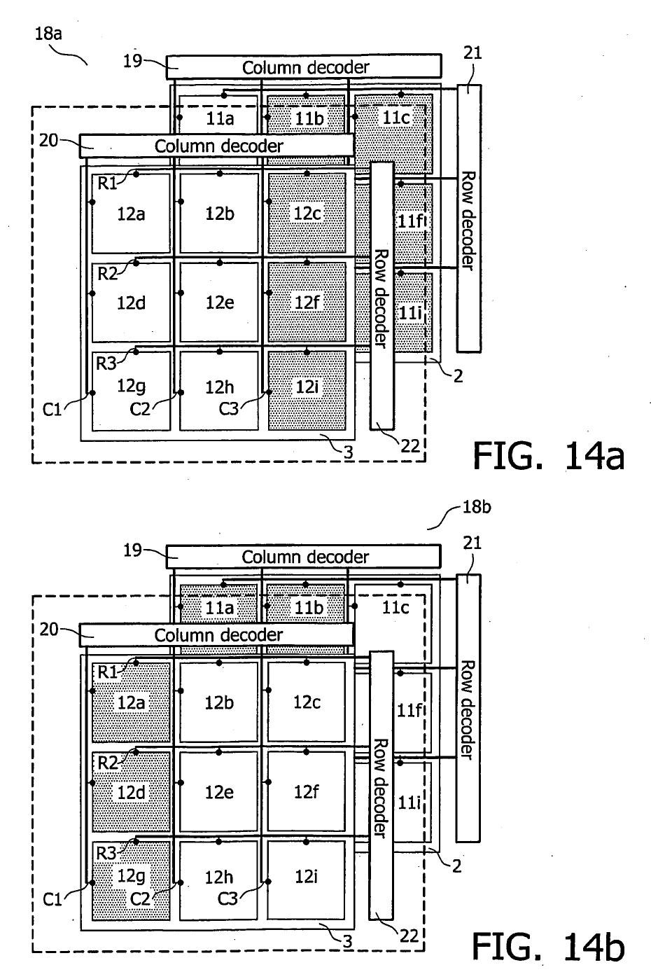

FIGS. 14(a)-(b) show an example of the electrode structure of the electro-optical cells required for the display in FIG. 13;

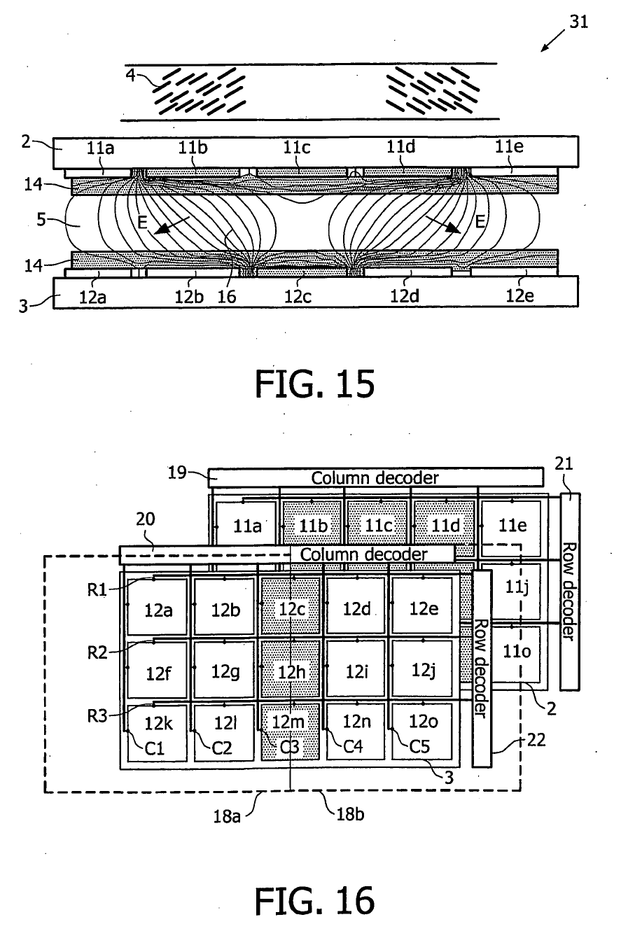

FIG. 15 shows an electro-optical cell where half the cell deflects the light to the left and half the cell deflects light to the right;

FIG. 16 shows an electrode structure of the electro-optical cell that can provide the deflection described in FIG. 15;

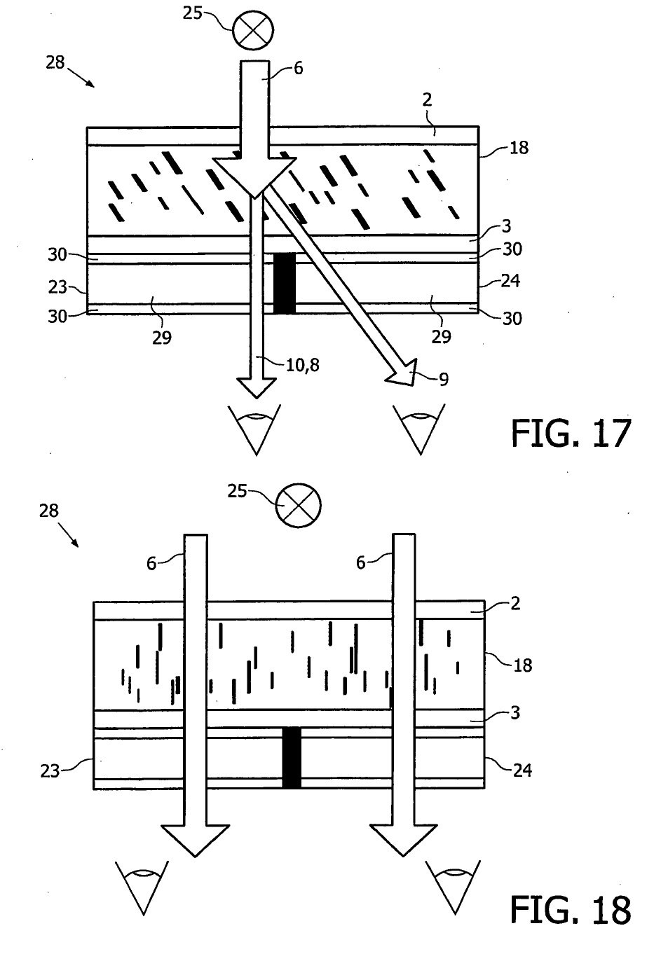

FIG. 17 shows part of a display comprising one electro-optical cell that deflects a portion of the light through an LC pixel and into one eye and transmits another portion of the light through another LC pixel and into the other eye;

FIG. 18 shows part of a display comprising two electro-optical cells in a transmissive state and two LC pixels;

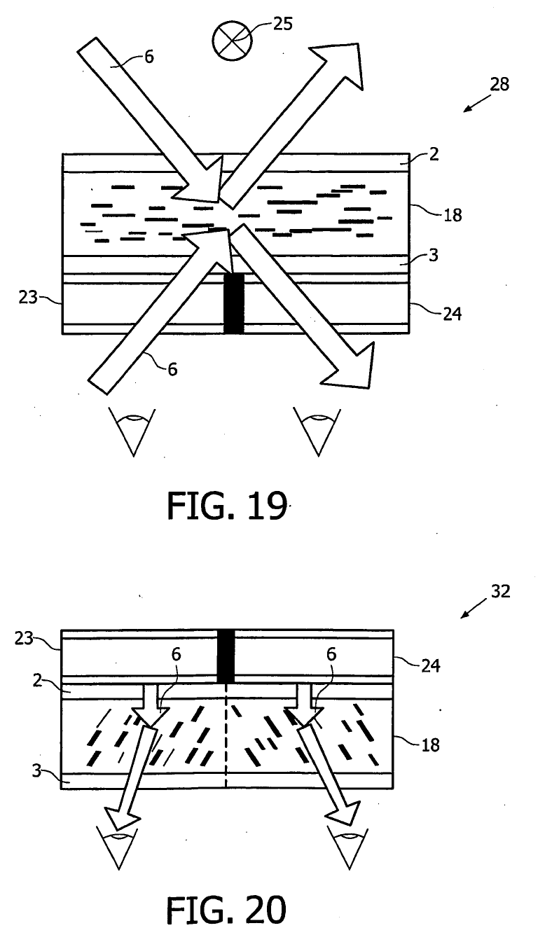

FIG. 19 shows the display in FIG. 18 in a reflective state;

FIG. 20 shows a different embodiment of a display comprising two electro-optical cells and two LC pixels wherein the display is in a 3 D display mode;

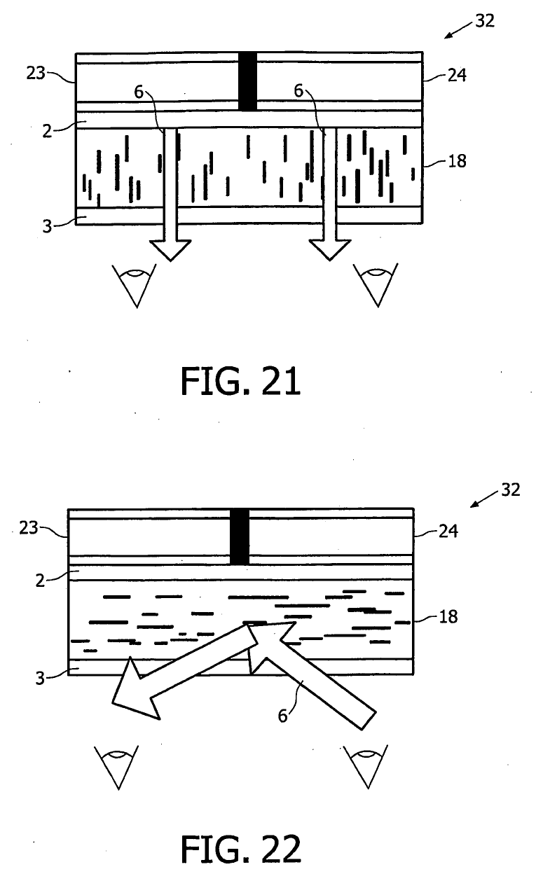

FIG. 21 shows the display of FIG. 20 in a transmissive state; and

FIG. 22 shows the display of FIGS. 20 and 21 in a reflective state.

FIG. 1 shows an electro-optical cell 1 with no electric field applied. The cell comprises two planar support members 2 and 3 with suspended particles 4 in a medium 5 between them. The support members are transparent and allow light 6 to pass through the cell. The particle suspension comprises a plurality of reflective particles suspended in an insulating fluid. The particles are further anisometric, i.e. they have unsymmetrical features. Typically, they are elongated platelets with unequal height, width and depth. The suspension medium may be butylacetate or a liquid organosiloxane polymer with a viscosity that permits Brownian motion of the particles but prevent sedimentation. Examples of suitable particles include metallic platelets of silver, aluminium or chromium, mica particles or particles of an inorganic titanium compound. The lengths of the particles are of the order 1 to 50 microns and they have a thickness of 5 to 300 nm. In FIG. 1 the particles are aligned at random. The light 6 will scatter off the randomly aligned particles 4. Accordingly, the cell does not transmit light well.

FIG. 2 shows the electro-optical cell with an electric field applied perpendicular to the support members 2 and 3. The particles 4 are aligned with their long axis parallel to the direction of the applied field resulting in that the light 6 can pass through the cell without being significantly scattered. Consequently, the cell is in a transmissive mode.

FIG. 3 shows the electro-optical cell when an electric field is applied parallel to the support members 2 and 3. The suspended particles consequently align with their long axis parallel to the field direction and perpendicular to the light 6. The cell may contain reflective particles that will reflect the light 6 as it scatters off the particles 4 and consequently the cell does not transmit the light. The non-transmissive configuration shown in FIG. 3 is preferable to the configuration shown in FIG. 1 when considering switching times. The switching time to obtain the orientation in FIG. 1 from a highly aligned state depends on the thermal relaxation of the particles while the switching time to the orientation in FIG. 3 depends on the electrical forces. The latter is much faster than the first in case of large particle size.

FIG. 4 shows the electro-optical cell when an oblique electric field is applied. The particles 4 align themselves at an angle with respect to the normal of the support members 2,3 and consequently the light going through will be deflected. However, only a portion of light will be deflected. FIG. 5 shows three beams 8, 9, 10 coming out of the cell. A small portion 8 of the light will go straight through the cell without being scattered off any particles. Another portion of the light 9 will scatter off an odd number of particles and be deflected at an angle twice the size of the angle 7 the particle makes with the normal of the support members. Moreover, a third portion 10 of the light will be scattered off an even number of particles, where the deflection caused by the second particle has opposite direction to the deflection caused by the first particle, resulting in that the transmitted beam is parallel to the incident beam.

FIG. 6 shows an example of the detailed electrode structure and cell features that can realise the electric fields described in FIGS. 2, 3 and 4. FIG. 6 shows an array of electrodes 11 and 12 on the support members 2 and 3 respectively. The electrodes 11 on support member 2 are aligned oppositely to the electrodes 12 on support member 3. Furthermore, the electrodes are separated by a gap 13 to allow insulation between the electrodes. The support members are typically made out of an insulating transparent material like glass, quartz, plastic or silicon oxide (SiO₂). The electrodes are typically formed using a conductive material like indium tin oxide (ITO) deposited in a CVD or sputtering process. The space between the support members includes a middle layer comprising the suspension medium 5 and two outer passivation layers 14, where the suspension medium 5 has a high dielectric constant while the passivation layers 14 have a lower dielectric constant. The purpose of the passivation layer 14 is to reduce the inhomogeneities in the electric field in the particle suspension of the cell. Possible passivation layers are fluoropolymers, which can be deposited by dipping the substrates 2,3, or SiO2, which can be sputtered or deposited by CVD etc.

A typical cell has a cell gap of 200 microns with a passivation layer of 50 microns, an electrode width of 250 microns and an electrode gap 13 of 50 microns. The middle layer 14 has an electric constant of 10 and each passivation layer 15 has a dielectric constant of 2.

FIG. 6 shows that the equipotential lines 15 in the particle suspension are comparatively parallel and the gradient of the field lines are to a large extent in the passivation layer. FIG. 6 also shows schematically how the suspended particles 4 are orientated in the cell. The particles 4 align perpendicular to the equipotential lines. To achieve the varying electric fields in FIGS. 6a, 6b and 6c the electrodes 11 and 12 have to be addressed differently for each electric field. The different shades of the electrodes in FIG. 6 indicate the different potentials. Light grey corresponds to negatively charged, white corresponds to positively charged and black corresponds to neutral.

FIG. 6a illustrates how an electric field perpendicular to the support members is realised. Having opposite potentials on the electrodes 11 of the first support member and the electrodes 12 of the second support member results in an electric field perpendicular to the support members. FIG. 6b shows how having opposite charges on the right hand and left hand electrodes respectively results in an electric field aligned with the support members and FIG. 6c shows how addressing the electrodes asymmetrically results in an electric field at an oblique angle with respect to the support members. The oblique angle of the electric fields in the electric cell are not restricted to the oblique angle of FIG. 6c. The oblique angle can be further tuned by addressing other appropriate electrode combinations which will be clear to the skilled reader.

In order to obtain the oblique configuration three electrodes on each support member are used in FIG. 6c. Consequently, six electrodes are used to create an electro-optical cell that partly deflects the light. A cell containing six electrodes can also be configured to be transmissive and reflective.

A suspended particle in an electro-optical cell subject to one electric field has more than one degree of freedom. FIG. 7a shows four particles subject to an electric field at an oblique angle from the left hand side of the second support member to the right hand side of the first support member. The electrodes on the support members are not shown. Particle 16 and particle 17 have different orientations but both are aligned with the electric field. The light passing through the cell will be observed to be reflected into a reflection circle resulting from that the light is reflected off all sides of the tube formed by the particles in FIG. 7a. The diameter of the reflection circle depends on the angle the particles make with the direction of the light. However, a second field, FIG. 7b, perpendicular to the first field, can be applied to avoid the reflection ring. When the two fields are applied intermittently the orientation that satisfies both fields is selected. The orientation of particle 17 satisfies both fields. Thus the degrees of freedom of the particle are reduced and the precise selection of the orientation of the particle can be achieved. If the particles are in a reflective state, selecting an orientation of most particles wherein the large area of the particle is parallel to the substrate results in a highly reflective state. A highly reflective state cannot be accomplished when the particles have more than one degree of freedom.

In order to reduce the number of degrees of freedom of the suspended particles a cell 18, comprising a matrix of electrodes 11 and 12, can be used as will be described with reference to FIG. 8. The first and second support members, 2 and 3, comprise nine electrodes each arranged in rows, R1 to R3, and columns, C1 to C3, of three electrodes. Each row can be addressed with a row decoder 19 and 20 and each column can be addressed with a column decoder 21 and 22. At each node between the electrodes and the connection to the voltage source there is a switch (not shown) such that each electrode can be insulated from the rest of the electrodes in the cell. Accordingly, the electrodes can be addressed individually. The row and column decoders and the switches are further connected to driving electronics (not shown). Alternatively, an active matrix arrangement can be used to individually address each electrode.

FIG. 8a shows the columns on the first and second support member addressed asymmetrically. Column C1 is positively charged on both the first and second support member, column C2 is negatively charged on the first support member and positively charged on the second support member and column C3 is negatively charged on both the first and second support member. The asymmetrically charged electrodes create an electric field at an oblique angle from the right hand side of the first support member 2 to the left hand side of the second support member 3 as shown in FIG. 8b. The particles align with more than one degree of freedom as shown by particle 16 and 17. However, if a second electric field is applied, as shown in FIG. 8c, only one of the orientations satisfies both fields. The orientation of particle 16 in FIG. 8b would not be allowed by the second electric field. On the other hand, the second electric field allows the orientation of particle 16 in FIG. 8d that would not have been allowed by the first field. However, the orientation of particle 17 is allowed by both fields. Consequently, if the first and second fields are applied intermittently most particles adopt the orientation of particle 17. The field in 8c and 8d is parallel to the support members, i.e. it comes out of the plane of the paper in FIG. 8d, and it is realised by making the top row R1 of both the first and second support member oppositely charged to the rest of the electrodes. The two fields should be applied repeatedly at a rate faster than the relaxation time of the particles in order to force the particles into a specific orientation. Alternatively, by means of AC fields of different frequencies the two perpendicular fields can be applied intermittently with short time intervals, such that the equilibrium state of each field is never reached and accordingly the particle adopts the orientation allowed by both fields.

Furthermore, the cell can be made non-transmissive and highly reflective by addressing the cells as shown in FIG. 9. In 9a the electrodes on the first and second support member, 2 and 3, are addressed symmetrically with the right hand column C3 oppositely charged to the electrodes in the other columns realising an electric field parallel to the support members from the right hand side to the left hand side as shown in FIG. 9b. The second field, achieved by the charged electrodes in FIG. 9c is also parallel to the support members but perpendicular to the field in FIGS. 9a and 9b and accordingly the particle is forced into the orientation shown by particle 17. The orientation shown by particle 16 is not allowed when both electric fields are applied repeatedly.

Furthermore, the cell can be made transmissive by addressing the electrodes on the first support member to have the opposite charge to the electrodes on the second support members resulting in that the particles align in a configuration perpendicular to the support members. By applying a second field shown by FIG. 10 the orientation of particle 17 is selected. However, in the transmissive state a second field is not required since neither of the particles have an orientation that would interact with the incoming light. When comparing FIGS. 8, 9 and 10 it is clear that the second field realised by the charged electrodes in FIGS. 8c, 9c and 10c can remain the same in the deflective, reflective and transmissive state even though it doesn't add value to the transmissive state. Only one of the fields needs to be changed to switch the cell into a deflective, reflective or transmissive state. Accordingly, even if a second field is required to be able to control the orientation of the particles, only one of the fields need to be switched in order to switch the electro-optical cell into a new state. Consequently, if the invention is used in an application where a reduced number of electrodes is advantageous, an alternative electrode arrangement can be used wherein electrodes common to a number of electro-optical cells are utilised for providing the second field.

The construction of a 3 D image according to the invention will now be described. The conventional way of constructing a 3 D image is shown in FIG. 11. The display is made up of columns of pixels, 23 and 24, where half the pixels 23 contain information for the left hand eye and half the pixels 24 contain information for the right hand eye. If the images represented by the pixels for the left and right hand eye were viewed separately, the images would be identical but slightly shifted to account for parallax between the eyes. When both of the images are seen simultaneously by the appropriate eyes a 3 D image appears. In the prior art the light beam associated with each pair of pixels originates from a separate light source 25, 26 or 27. The separate light sources are typically produced by a backlight emitting light at specific spatial intervals across the display, e.g. slits in a filter in front of a normal backlight, or by lenticular lenses spreading the light in different angles. In the examples of the invention described hereinafter an individual electro-optical cell associated with each pixel can be used to construct a 3 D image. The electro-optical cell can be operated to deflect the incident light in the appropriate direction and through the appropriate pixel. FIG. 12 shows how a display comprising an electro-optical cell behind each pixel deflects the optical radiation at the appropriate angles. The shaded pair of pixels with associated electro-optical cells 28 will be described in more detail in FIG. 13.

FIG. 13 shows part of a the display 28 comprising two electro-optical cells, 18a and 18b, behind two liquid crystal pixels 23 and 24 containing information for the left hand eye and right hand eye respectively. The pixel display is not restricted to liquid crystal displays. Any type of passive displays can be used such as electrowetting, electrophoretic, electrochromic or other light valve displays. The pixels are made. up of liquid crystals 29 sandwiched between electrodes on a substrate 30. The left electro-optical cell 18a partly deflects the light through the left pixel 23 and into the left eye. The right electro-optical cell 18b partly deflects the light through the right pixel 24 into the right eye. The portion of the light that continues straight through the electro-optical cell parallel to the incident light can be minimised by the correct concentration of particles or blocked by appropriate construction of the cell. For example, an optical shutter can be placed some distance from the electro-optical cell, where the deflected and straightforward beams are spatially separated. FIG. 14 shows the details of the potential on the electrodes required to realise the deflection required for the electro-optical cells in FIG. 13. In FIG. 14a the electric field is realised with a direction from the right hand side of the first support member 2 to the left hand side of the second support member 3 realising the field of cell 18a. In FIG. 14b an electric field is achieved with a direction from the left hand side of the first support member 2 to the right hand side of the second support member 3 equivalent to the field of cell 18b.

FIG. 15 illustrates a way of reducing the number of electrodes required to create two beams wherein each beam is directed towards a different eyes. It shows five electrodes in a row on the first support member 2 and five electrodes in a row on the second support member 3. FIG. 16 shows three rows of five electrodes on the first support member 2 and on the second support member 3. Since column C3 of the left electro-optical cell 18a and column C1 of the right electro-optical cell 18b (in FIG. 14) are of the same potential, the two columns can be combined into one column and thus the number of columns are reduced from 6 to 5. The new cell 31 has column C2 to C4 on the first support member and columns C3 on the second support member negatively charged and the other columns positively charged. The charged electrodes realise a field that cause the light entering the cell to the left of the centre to be deflected to the left and the light entering to the right of the centre to be deflected to the right. A further reduction is possible and would lead to four electrodes per row.

FIG. 17 illustrates a feature of the electro-optical cell that can be utilised to reduce the number of electrodes required further, thereby increasing the resolution of the display. As described with reference to FIG. 5 only a portion of the incident light is deflected. Another portion of the light is transmitted parallel to the incident beam. The light transmitted parallel to the incident beam, 8 and 10, can be used as a beam directed towards the right hand eye and the deflected beam 9 can be directed towards the left eye or vice versa. A display using one electro-optical cell per every pair of pixels and wherein both the transmitted and the deflected beam in the electro-optical cell are used has twice the resolution of a display having one electro-optical cell per pixel.

FIG. 18 shows part of the display 28 wherein the electro-optical cell 18 is in a transmissive mode. The light passes through the cell without being deflected towards a particular eye. If the information conveyed by the pixels is information that forms a 2 D image the switching between a 3 D display mode and a 2 D display mode can be accomplished by switching the electro-optical cells from a deflective to a transmissive mode. The size of the windows switched between a 3 D and 2 D mode may be as large as the size of the display or as small as an individual electro-optical cell allowing the user to pick areas of the display to be switched. FIG. 19 shows parts of the display 28 when the electro-optical cell 18 is in a reflective mode. The light from the backlight is then reflected; thus, no light reaches the pixels from the back. Consequently, it can be switched off to reduce power consumption. This state can be utilised when there is enough ambient light in the environment to illuminate the. display. Thus, the electro-optical cell can be used as a transflector.

Another embodiment of the invention is shown in FIG. 20. The display 32 now comprises pixels, 23 and 24, positioned behind the electro-optical cells 18. In this embodiment the display device comprising the pixels could be made out of a device that incorporates a light source like polyLED or CRT. Thus, a separate backlight is not required for these examples. However all transmissive displays, such as backlit LCD displays, may be used as well. The light entering the deflective electro-optical cell already contains the information for a 3 D image and is deflected towards the appropriate eye. In a transmissive state, FIG. 21, the pixels may contain information for a 2 D image and consequently, windows of the display can be switched between 2 D and 3 D display mode. FIG. 22 shows the electro-optical cell in a reflective mode. No light can pass through the display but ambient light will be reflected off the display. Thus, the display will now appear to be a mirror.

It should be clear that the electrode arrangements are not restricted to the drawings above. In the examples above, the smallest electro-optical cell that can deflect the light into two beams, one for each eye, without causing reflection rings, contains nine electrodes on each support member. Using additional electrodes and changing the magnitude of the electric fields and the charge on the electrodes a number of additional deflection angles, not described above, can be realised. Due to that the angle the particles make with respect to the support members is controlled by the electric fields the deflection of the light can be changed during operation of the display. A 3 D image can have more than one view so that when the viewer moves the head a new view will be seen. The number of views and viewing directions may be changed as the display is in operation and will not be restricted to the hardware of the display as the electro-optical cells can be altered accordingly by applying varying electric fields.

Although Claims have been formulated in this Application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any Claim and whether or not it mitigates any or all of the same technical problems as does the present invention. The Applicants hereby give notice that new Claims may be formulated to such features and/or combinations of such features during the prosecution of the present Application or of any further Application derived therefrom.

1. An electro-optical cell (1, 18) comprising first and second support members (2, 3) at least one of which is transparent to optical radiation (6),
a suspension of anisometric particles between the support members (5), and
an electrode arrangement (11, 12) on at least the first support member (2) to apply a first electric field to the particle suspension (5) in such a manner that at least a major proportion of the particles (4) are aligned in an oblique configuration relative to the support members (2, 3) in a predetermined region thereof so as to guide obliquely the optical radiation (6) passing between the support members.

2. An electro-optical cell (1, 18) of claim 1 wherein the electrode arrangement (11, 12) is on both the first and second support members (2, 3).

3. A display (28, 32) comprising:
a source (25) of optical radiation (6),
a display device comprising an array of pixels (23, 24), and
a plurality of electro-optical cells (1,18) as claimed in claim 1.

4. A display (28, 32) of claim 3 wherein different ones of the electro-optical cells (1, 18) are configured to direct the optical radiation in different directions.

5. A display (28, 32) of claim 4 wherein a first group of the electro-optical cells (18a) are configured to direct the optical radiation to the left eye and a second group (18b) of the electro-optical cells are configured to direct the optical radiation to the right eye.

6. A display (28, 32) of claim 5 wherein the electro-optical cells of the first group are interspersed with the electro-optical cells of the second group in recurring patterns.

7. A display (28, 32) of claim 6 wherein the pattern comprises a pair of electro-optical cells (18a, 18b) containing a first and a second electro-optical cell,
the first electro-optical cell (18a) deflects the optical radiation to the left eye,
the second electro-optical cell (18b) deflects the optical radiation to the right eye, and
a plurality of said pairs are aligned side by side in a line.

8. A display (28, 32) of claim 3 wherein the electro-optical cell (1, 18) is further configured such that optical radiation (6) from the source (25) incident in a first direction on the electro-optical cell (1, 18) is split into a first beam (8, 10) generally parallel to the first direction to be directed to one eye and a second beam (9) in an oblique direction corresponding to the oblique particle configuration to be directed to the other eye.

9. A display (28, 32) of claim 3 wherein the electro-optical cells (1, 18) comprises three electrodes (11a, 11b, 11c) on the first support member forming a first row (R1),
each of the three electrodes has an oppositely aligned electrode on the second support member (12a, 12b, 12c), and
the electrodes on the first and second support member are configured to be asymmetrically charged in order to apply the first electric field.

10. A display (28, 32) of claim 9 further comprising means for reducing the number of degrees of freedom of the suspended anisometric particle (16, 17).

11. A display (28, 32) according to claim 10 wherein the means for reducing the number of degrees of freedom of the particle comprise the electro-optical cell (18) having another two rows of electrodes (R2, R3), identical to the first row, in a matrix, on the first support member (2), and each of the electrodes in the three rows (11a-11i) has an oppositely aligned electrode on the second support member (12a-12i) and the electrodes on the first and second support members are operable to apply an electric field perpendicular to the first electric field such that the suspended particle (17) is forced to align with both fields.

12. A display (28, 32) of claim 3 wherein the electro-optical (18, 1) cell is configured such that optical radiation incident (6) in a first part of the cell is partly deflected to the left eye and optical radiation (6) incident in a second part of the cell is partly deflected to the right eye.

13. A display (28, 32) of claim 12 wherein the electro-optical (18, 1) cell comprise electrodes (11a-11e) on the first support member (2) forming a second row (R1),
each of the five electrodes have an oppositely aligned electrode (12a-12e) on the second support member (3), and
the electrodes on the first and second support member can be addressed to create a first electric field in order to align the particles (4) such that optical radiation (6) entering the cell to the left of the centre is to be partly deflected to the left eye and optical radiation entering the cell to the right of the centre is to be partly deflected to the right eye.

14. A display (28, 32) of claim 13 wherein the second row (R1) comprises five electrodes.

15. A display (28, 32) of claim 14 further comprising means for reducing the number of degrees of freedom of the suspended particles (16, 17).

16. A display (28, 32) of claim 15 wherein the means for reducing the number of degrees of freedom of the suspended particles (16, 17) comprise the electro-optical cell (18) having another two rows (R2, R3) identical and adjacent to the second row (R1) in a matrix on the first support member (2) and each of the electrodes (11a-11o) of the matrix has an oppositely aligned electrode (11a-12o) on the second support member (3) and the electrodes on the first and second support member are configured to create an additional electric field that forces the particles (17) to align with both electric fields.

17. A display (28, 32) of claim 4 wherein the optical radiation (6) intended for the right eye subsequently passes through display pixels operable to contain information for the right eye (24), the optical radiation intended for the left eye subsequently passes through display pixels operable to contain information for the left eye (23),
and wherein the combination of the information for the left and right eye allows the construction of a 3 D image.

18. A display (28, 32) of claim 17 that is operable to provide a first display window, which is switchable into transmissive mode,
wherein the size of the window corresponds to the size of a group of electro-optical cells (1, 18),
said group comprises at least one electro-optical cell,
the electro-optical cells of the group are operable to apply an electric field, perpendicular to the support members (2, 3), to the particle suspensions (5) of said group in such a manner that at least a major proportion of the particles (4) in said group are aligned in a configuration generally perpendicular to the support members in a predetermined region thereof so as to cause negligible obstruction to the optical radiation (6) passing between the support members.

19. A display (28, 32) of claim 18 wherein the optical radiation (6) passing through said first window is subsequently passed through pixels (23, 24) operable to contain information for the construction of a 2 D image such that the window can be switched between a 2 D and 3 D display mode.

20. A display (28, 32) of claim 18 that is operable to provide a second window which is switchable to reflective mode,
wherein the size of the window corresponds to the size of a group of electro-optical cells (1, 18),
said group comprises at least one electro-optical cell, and
the electro-optical cells of the group are operable to apply an electric field, aligned with the support members (2, 3), to the particle suspensions (5) of said group in such a manner that at least a major proportion of the particles (4) in said group are aligned with the support members (2, 3) in a predetermined region thereof so as to reflect the optical radiation (6) passing between them.

21. A display (28, 32) of claim 20 wherein the first window is the same as the second window.

22. A display (28) of claim 3 wherein the electro-optical cells (1, 18) are positioned between the source of optical radiation (25) and the display device (23, 24).

23. A display (28) of claim 22 wherein the display device (23, 24) is a liquid crystal device.

24. A display (28) of claim 22 wherein the pixels (23, 24) are operable to contain information for a 2 D image such that when said second window is in a reflective mode ambient light can be reflected to construct a 2 D image in said second window.

25. A display (32) of claim 3 wherein the electro-optical cells (1, 18) are positioned in front of the display device (23, 24).

26. A display (32) of claim 25 wherein the display device (23, 24) comprises an emissive display, such as a polyLED device, a Cathode Ray Tube (CRT), a plasma display, a field emission display, back-lit light valve display or an OLED display.

27. A display (32) of claim 25 wherein the second window appears to be a mirror when the second window is in a reflective mode.

28. A display (28, 32) of claim 3 wherein the angle of deflection can be adjusted to accommodate different users or operation at different distances.

29. A display (28, 32) of claim 1 comprising driving electronics to change the potential of the electrodes (11, 12) in order to switch the orientation of the suspended anisometric particles (4).
